(19) United States
(12) Patent Application Publication
(10) Pub. No.: US 2019/0011015 A1
(43) Pub. Date: Jan. 10, 2019

(54) Self-adhesive balancing weight for a vehicle wheel

(71) Applicant: WEGMANN automotive GmbH & Co. KG, Veitshochheim (DE)

(72) Inventors: Thomas Hornung, Wurzburg (DE); Benedikt Kuhn, Guntersleben (DE); Simon Schenker, Eisenheim (DE); Hubert Schwenold, Winterlingen-Harthausen (DE)

(21) Appl. No.: 15/999,571

(22) Filed: Aug. 20, 2018

Related U.S. Application Data
(63) Continuation of application No. PCT/EP2017/053689, filed on Feb. 17, 2017.

(30) Foreign Application Priority Data
Feb. 19, 2016 (EP) 16156457

(51) Int. Cl. F16F 15/32

(52) U.S. Cl. CPC F16F 15/328

(57) ABSTRACT

A self-adhesive balancing weight for a vehicle wheel has a top surface and a bottom surface with a self-adhesive tape. The bottom surface has a first curved section having a first radius and a second curved section having a second radius. The first radius is smaller than the second radius. This configuration allows to hold the balancing weight by the adhesive tape to almost every rim, as there are always at least two holding points (or holding lines) at which the balancing weight contacts the rim via the adhesive tape.

### CROSS-REFERENCE TO RELATED APPLICATIONS

This application is a continuation of the pending International Application No. PCT/EP2017/053689 filed on 17 Feb. 2017, which designates the United States and claims priority from the European Application No. 16156457.0 filed on 19 Feb. 2016. The disclosure of each of the above-identified patent applications is incorporated herein by reference.

### BACKGROUND

1. Field of the Invention

The invention relates to a self-adhesive balancing weight, which may be attached to the rim of a wheel of a vehicle for balancing the wheel.

2. Description of Relevant Art

The contact surface of self-adhesive balancing weights generally is formed so as to accurately fit to the counter surface of the wheel rim holding the weight to provide as much contact surface and thereby adhesive surface area as possible in order to ensure safe fixation. As the rim profiles of different types of wheels—coming from different wheel manufactures for instance—differ in a wide range, a great number of different balancing weights has to be kept on stock. Particularly, the counter-surface of aluminum wheel rims, to which the balancing weights have to be fixed, often are concave-convex shaped so that accurate adaptation of balancing weights is difficult.

WO 99/00609 discloses self-adhesive balancing weights the contact surfaces of which are exactly complementary to the shape of the counter-surface of the respective wheel rim so that they could not be used with wheel rims of different shape.

US 2007/0108834 A1 discloses a balancing weight body filled with mass material particles.

FR 1.309.852 discloses a balancing weight with a curved attachment section.

There is a large number of different rim geometries in the market. Furthermore, there are significant mechanical tolerances in the rims which may be in an order of 1 mm.

For reliably attaching balancing weights to a rim, there exist two basic concepts. Self-adhesive balancing weights usually have a planar back surface which is designed to adhere to an at least essentially planar surface which is curved only around the rotational axis of the wheel. Accordingly, the self-adhesive balancing weights have to be bent only in one axis. The second type of balancing weights are clip-on balancing weights which are held to the rim by a spring clip. These balancing weights usually are held in an outer groove of the rim and therefore must at least roughly be adapted to the contour of the groove. Due to the large number of different grooves, at least a significant number of differently formed balancing weights is required.

### SUMMARY

The embodiments are directed to providing self-adhesive balancing weights configured to fit to rims of several different shapes. Therefore, a situation is achieved when only a small number of balancing weights or only a single type of balancing weights are configured to fit to a broad variety of rims.

For finding a solution of the problem, a large number of rims have been analyzed and checked for appropriate locations for mounting of balancing weights. It was discovered that a balancing weight that fits to most rims on the market, possesses the following features.

A balancing weight has a top surface that in practice may be configured to have any shape, but preferably is a planar surface. Approximately opposed to the top surface there is a bottom surface, which is preferably designed to be held to the rim by means of a self-adhesive tape. The self-adhesive tape preferably is attached to the bottom surface or parts or portions thereof. In an alternate embodiment, the balancing weight may be held to the rim by means of a clip. Furthermore, it is preferred that the balancing weight have at least one or two extensions, by which the balancing weight may be held by a robot or a person when the balancing weight is attached to a rim.

The bottom surface, which also serves as an attachment surface, has at least two curved surface portions or sections with different radii. There is a first curved surface portion or section having a first radius and a second curved portion or section having a second radius. Between the first and second curved surface portions or sections (first and second curved sections, for short) and the top surface of the balancing weight or the extensions of the balancing weight, there may be present an approximately straight section or a plurality of straight sections, which either preferably have a comparatively large curve radius (that is significantly larger than that of the second curved section), or are straight. Although in one embodiment, the first curved section is located next to the second curved section, in an alternate embodiment, there may be a straight section between the first curved section and the second curved section. At the first curved section, opposite to the second curved section, there may be a third curved section.

The radius of the first curved section is smaller than that of the second curved section. The first and/or the second curved sections may have notches or recesses for further enhancement of affixation to the rim. The radius of the third curved section may be smaller than the radius of the first curved section, but it is preferred to have a larger radius. Preferably, the radius of the third curved section is the same as the radius of the second curved section, while both of these radii are larger than the radius of the first curved section.

Preferably, a recess is provided within the first curved section. The recess may have the shape of a flat blind hole. The recess may be circular, rectangular or have any other shape. The area of a cross section of the recess may be between 50% and 10% of the surface area of the first curved section. The depth of the recess may be between 1 mm and half of the thickness of the balancing weight. The presence of the recess results in a lowered/reduced surface area of the first curved section. Due to the lowered surface area, the total force required to compress an adhesive tape located at the first curved section is smaller as compared to a similar force associated with the second and the third section. This helps to adapt the balancing weight to rims when the shape of the rim is such that the distance between the rim and the first section is smaller than the distance between the rim and the second and/or third sections, requiring a higher compression at the first curved section.

It is further preferred, if the length of the second section is larger than the length of the first section. It is furthermore preferred, if the length of the third section is smaller than the length of the first section.

Preferably, the first, second and third curved sections are convex shaped (or convex, for short).

It is preferred, if the self-adhesive tape is disposed on the first curved section and on the second curved section. In this case, the self-adhesive tape is disposed to preferably cover the first curved section and the second curved section in a tangential direction. Most preferably, the self-adhesive tape (optionally completely) covers the first curved section and the second curved section in a tangential direction (that is, in a direction of an axis that is tangential to a given curved section).

There may be one or two additional curved sections limiting the extent of the bottom surface against the top side. These additional curved sections are different from the first curved section and the second curved section.

Most preferably, the first and second curved sections form contact points with a rim and such contact points define at least a contact line (a line of contact with a rim). There is a contact established between the balancing weight and the rim over the length of the balancing weight at these contact points. The contact may even be formed at a larger contact area, if the curvature of the rim is very similar to the curvature of the bottom surface of the balancing weight. If there are only small deviations/differences between these two curvatures, or a small variation in distance between the rim and the balancing weight, such differences and/or deviations will be compensated by the adhesive tape. In the use of an embodiment of a balancing weight configured for use with the rims made of aluminum, there may be established at least one contact line or even a contact area between the rim and at least one of the straight sections.

Herein, the terms “contact points” and “contact lines” are used. In a given sectional view of the balancing weight, the area of contact between the balancing weight and a rim may look like (appear to be) a point. However, there exists a projection of the contact point forming a contact line in the direction of the length of the balancing weight. In this document both terms “contact point” and “contact line” are used as equivalent to one another as described above.

Both curved sections result in at least two contact points, of the balancing weight with the rim, for a large variety of balancing weights, which results in a sufficient contact and a sufficient adhesive force to the rim. Due to the judiciously defined curves of the curved sections, the distance to the rim in case of any deviations of the form/shape of the rim is slightly decreasing. Such slight decrease of the distance may easily be absorbed or compensated for by a self-adhesive tape between the balancing weight and the rim, thereby resulting in a comparatively large section in which adhesive forces apply. Preferably, the first radius of the first curved section is about a half of the second radius of the second curved section. Preferably, the first radius is about 4 mm while the second radius is about 8 mm. These values may be modified in a range of ±50%, preferably within ±30%, and most preferably within ±10%.

In a related embodiment, preferably, the first radius of the first curved section is about ⅕ of the second radius of the second curved section. Preferably, the first radius is about 1.8 mm while the second radius is about 9 mm. These values may be modified in a range of ±50%, preferably within ±30%, and most preferably within ±10%. It is further preferred, if there are two straight sections between each of the first and second curved sections and the top surface. Preferably, the angle formed by such straight sections with one another is 90 degrees. Optionally, the angle may vary by less than ±30 degrees, preferably less than ±20 degrees, and most preferably less than ±10 degrees. Preferably, the first radius is by 1 mm smaller than the second radius which is 8 mm, with a tolerance of these two values of radii of ±50%, while the preferred tolerance is +/−30%.

Preferably, the center axis for the first radius goes or passes through (traverses) the balancing weight body, while it is preferred, that the center axis for the second radius (in one embodiment—an axis in which a center of the curvature is located) is outside of the balancing weight body.

The balancing weights may be made from any material as known from the art. The material preferably comprises zinc or steel. It is further preferred, if the balancing weights have at least one inlay of a ferromagnetic material, for example, iron or steel, which would allow the use of a magnetic picking head to handle the balancing weights.

In a preferred embodiment, there are gaps or cutouts at at least one side and preferably at both (opposing) sides of the self-adhesive tape, which allow easier bending of the tape to adapt to a radius of a rim. Such gaps or cutouts are preferably disposed between the balancing weights.

A further embodiment relates to a chain or a belt of balancing weights comprising a plurality of balancing weights configured as disclosed in this document. These weights are interconnected by the self-adhesive tape.

All the embodiments disclosed herein may be combined in any sequence.

### BRIEF DESCRIPTION OF THE DRAWINGS

In the following, the invention is described by way of examples, without limitation to the general inventive concept, and with reference to the drawings.

FIG. 1 shows a first embodiment, preferably for steel rims.

FIG. 2 shows the first embodiment in a top view.

FIG. 3 shows a sectional cut of the first embodiment.

FIG. 4 shows an enlarged sectional cut of the first embodiment.

FIG. 5 shows an enlarged sectional cut of a second embodiment.

FIG. 6 shows a slightly modified embodiment in a sectional view.

FIG. 7 shows a further modified embodiment in a sectional view.

FIG. 8 shows the embodiment in a second sectional view.

FIG. 9 shows the embodiment in the perspective view.

FIG. 10 shows a first sectional view of an embodiment with a recess.

FIG. 11 shows the embodiment in a second sectional view.

FIG. 12 shows the embodiment in the perspective view.

FIG. 13 shows a balancing weight of a first embodiment mounted to a rim.

FIG. 14 shows the balancing weight on a rim in detail.

FIG. 15 shows a chain of balancing weights from the bottom side.

FIG. 16 shows a self-adhesive tape with gaps or cutouts.

While embodiments of the invention can be variously modified and assume alternative forms, specific embodiments are shown by way of examples in the drawings and described in detail below. It should be understood, however, that the drawings and detailed description are not intended to limit the invention to the particular form disclosed, but on the contrary, the scope of the intention is to cover all modifications, equivalents and alternatives as recited in the appended claims.

### DETAILED DESCRIPTION

In FIG. 1, a first embodiment, configured for use with preferably a steel rims, is shown. A balancing weight 10 has a top surface 12 and a bottom surface 11 opposing to the top surface. The top surface may bear at least one marking and/or ornamental design. In this embodiment, there is a first line 15 that indicates the operational orientation of the balancing weight and, in operation, is supposed to be aligned approximately parallel to the circumference of the rim. Also present is a second line 16, which may be under a right angle to the line 15 and which includes two dashes in this embodiment, is defined in a radial direction, and points towards the axis of the wheel when the weight is installed. The bottom surface 11 has a specific contour dimensioned to be adapted to a large number of different rims, which will be explained later in detail.

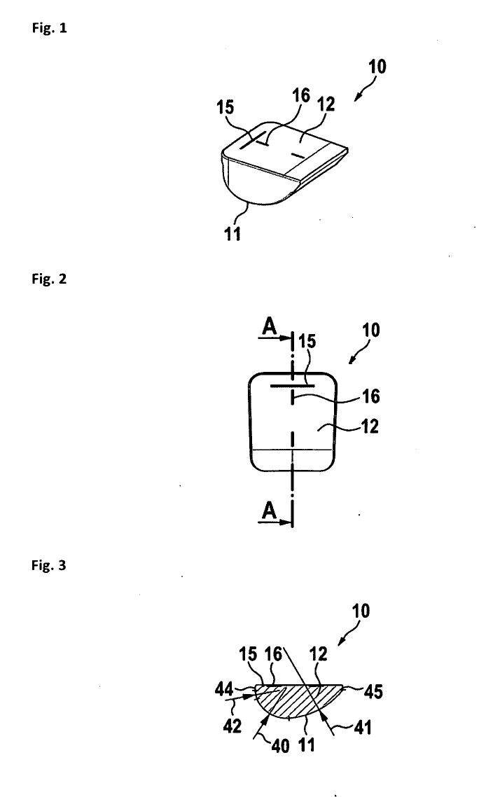

In FIG. 2, the first embodiment is shown in a top view. Here, a sectional cut A-A is indicated, which will be shown in detail in FIG. 3.

In FIG. 3, a sectional cut of the first embodiment is shown. This cut, as indicated in FIG. 2, is made along the cutting line A-A.

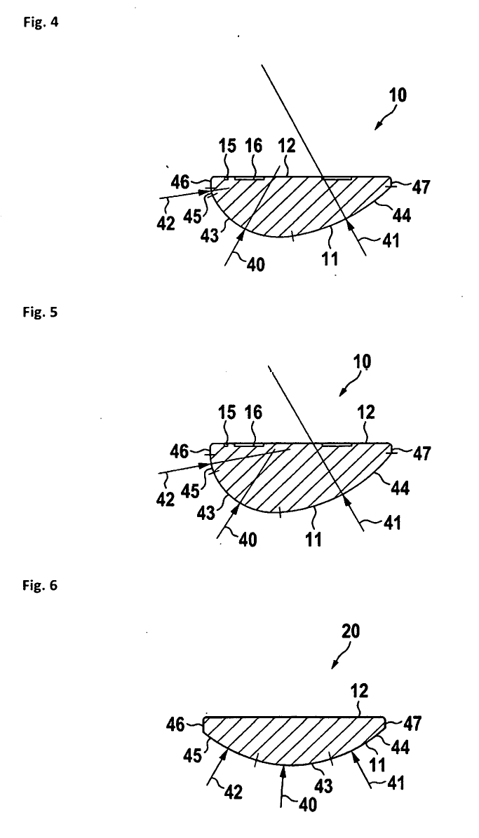

FIG. 4 shows a sectional cut similar to that of FIG. 3. For better visibility, this figure has been enlarged versus the previous figures. The bottom surface 11 of the balancing weight has at least a first curved section 43 and a second curved section 44. It is further preferred to have a third curved section 45. These sections are marked in FIG. 4 with short lines that are shown perpendicular to a perimeter of the sectional cut of the bottom surface 11. The first curved section 43 has a first length and a first radius of curvature 40. The second curved section 44 has a second length and a second radius of curvature 41. The third curved section 45, if present, has a third length and a third radius of curvature 42. The lengths of the radius-indicating and arrow-bearing lines 40, 41, 42 indicate the radius between a tip of a given arrow and the end of the corresponding line. The center axis for each curved section (43, 44, 45) therefore corresponds to a point at the end of the corresponding radius-indicating line (40, 41, 42). Preferably, the center axis for the first radius 40 (in this Figure—the axis that is perpendicular to the plane of the figure and passes through the center of curvature and the end of radius-indicating line) passes through the balancing weight body, while it is preferred, that the center axis for the second radius 41 is outside of the balancing weight body. In this embodiment, shown is a first straight section 46 between the third curved section 45 and the top surface 12, and a second straight section 47 between the second curved section 44 and the top surface 12. There may be a further straight section (not shown in this embodiment) between the first curved section 43 and the second curved section 44 and or a further straight section between the first curved section 43 and the third curved section 45. Any of the three curved sections or, alternatively, all three curved sections will result in at least two contact points with the rim of a large variety of balancing weights, which results in operably-sufficient contact with and an operably-sufficient force of adhesion to the rim if an adhesive tape is disposed between the balancing weight and the rim. Due to the curvatures of the curved sections, the distance to the rim in case of any deviations of the form of the rim is slightly decreased. Such a slight decrease in the distance may easily be compensated for by a self-adhesive tape disposed between the balancing weight and the rim, thus resulting in a comparatively larger section in which adhesive forces apply.

FIG. 5 shows a slightly different embodiment, where the third radius 42 is larger than the first radius 40, whereas in FIG. 4 the radius 42 is smaller than the first radius 40. Different ratio(s) of radii may be selected to get the broadest operation adaption of different balancing weights to various rims.

FIG. 6 shows a slightly modified embodiment of FIG. 5, with a symmetrical design, where the second radius 41 is equal to the third radius 42. The design of the bottom surface 11 comprising a first radius 40, a second radius 41, and a third radius 42 is adapted to fit to the 25 most commonly-used in Europe rims, and to a large number of rims used in the US as well as in other countries. It is preferred to have the radii of curvature of the first, second, and third curved sections in a range between 4 mm and 12 mm, whereas the radius of curvature of the first curved section is smaller than the radii of the second and third curved sections by about 0.5 mm to 3 mm. Most preferably, the radius of the first section is 7 mm, whereas the radius of the second and third sections is 8 mm.

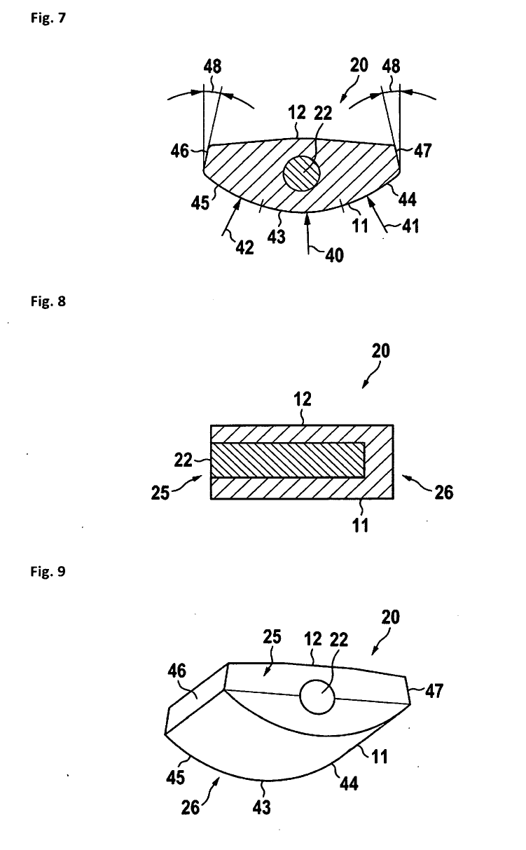

In FIG. 7 a further embodiment is shown. It is similar to that of FIG. 6, but has larger first and second side walls 46, 47. The sidewalls may be parallel to one another, or they may be tilted under an angle 48 inwards, as shown, such that the planes of the sidewalls intersect one another above the top surface 12.

The larger sidewalls provide the balancing weight with additional height and, therefore, volume and mass. Such sidewalls further may allow to include an inlay or insert element 22 (comprising a ferromagnetic and preferably a soft magnetic material). The purpose of the use of inlay is to improve the handling of a weight by a magnetic handling apparatus. Preferred materials of this inlay are iron or steel.

FIG. 8 shows a sectional view of the same balancing weight, of FIG. 7, through the center of the inlay. The sectional view shows that the inlay is extending from a front side 25 and preferably is flush with the front side. The inlay is preferably dimensioned to end or terminate before the rear side 26 (opposing the front side 25) is reached, such that it does not penetrate through the surface corresponding to the rear side.

FIG. 9 shows a perspective view of the balancing weight with all the features as explained above.

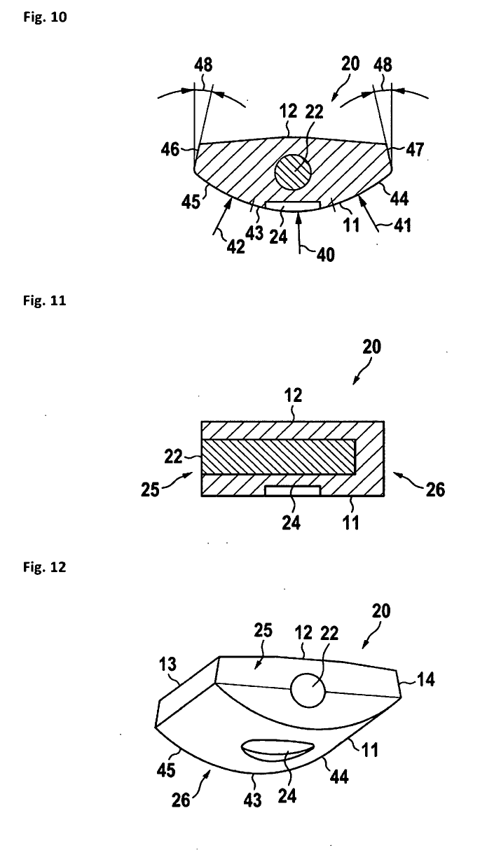

In FIG. 10 a balancing weight similar to the balancing weight discussed above is shown. Here, at the bottom surface, preferably at the center of the bottom surface, it is preferred to have a recess 24. This recess results in a lower surface area of the first curved section 43. Due to the lower surface area of the first curved section, the total force required to compress an adhesive tape located at the first curved section is reduced as compared to the force required to compress all adhesive tape disposed in cooperation with the second curved second and the third curved section. Such structure helps to adapt the balancing weight to rims, if the shape of the rim is such that the distance or space between the rim and the surface of the first curved section is smaller than the distance between the rim and the surfaces of the second and third curved sections.

FIG. 11 is a schematic of an embodiment similar to that of FIG. 8, but with the recess 24.

FIG. 12 is a schematic of an embodiment similar to that of FIG. 9, but with the recess 24. It has opposing sidewalls 13 and 14.

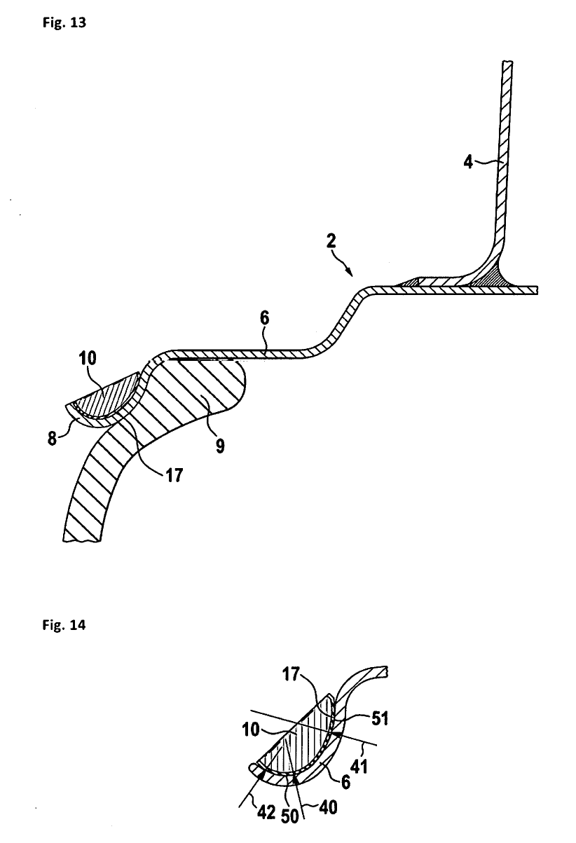

In FIG. 13, a balancing weight 10 mounted to a steel rim 2 of a wheel is shown in a cross-sectional view. A wheel rim 2 comprises at least a wheel disk 4 and a wheel band 6 ending in a wheel horn 8, as known from the art. A tire 9 is mounted to the wheel rim 2.

In FIG. 14, an enlarged section of a balancing weight on a rim is shown. There is first contact area 50 between the balancing weight and the rim at the first radius 40 or the third radius 42 of the balancing weight. Furthermore, there is a second contact area 51 between the second radius 41 of the balancing weight and the rim. These two contact areas are at some distance to one another and are large enough to hold the balancing weight reliably and durably affixed to the rim at a chosen position for a long time durable.

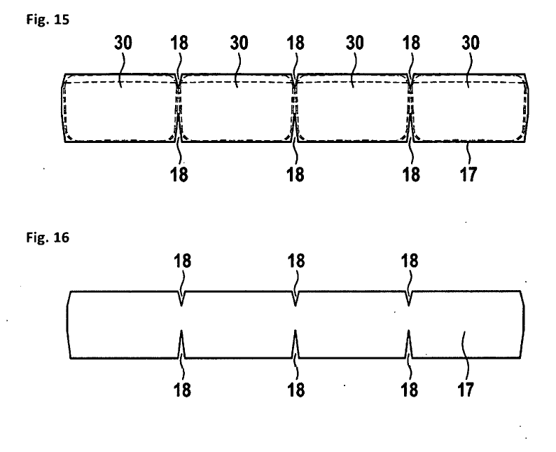

FIG. 15 shows a chain of balancing weights from the bottom side. Here, preferably, gaps or cutouts 18 are provided in the self-adhesive tape, as shown, which gaps or cutouts allow for and facilitate easier bending of the tape to adapt the chain of weights to a radius of a rim.

FIG. 16 shows a preferred embodiment of a self-adhesive tape 17. Here, gaps or cutouts 18 are provided, which may allow easier bending of the tape to adapt to a radius of a rim. Such gaps or cutouts may be formed at one side of the tape only or at both sides of the tape as shown.

It will be appreciated to those skilled in the art having the benefit of this disclosure that this invention is believed to provide balancing weights for vehicle wheels. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

2 wheel rim

4 wheel disk

6 wheel band

8 wheel horn

9 tire

10 balancing weight

11 bottom surface

12 top surface

13 first sidewall

14 second sidewall

15 first line

16 second line

17 self-adhesive tape

18 cutout

20 balancing weight

22 inlay

24 recess

25 front side

26 rear side

30 balancing weight

40 first radius

41 second radius

42 third radius

43 first curved section

44 second curved section

45 third curved section

46 first straight section

47 second straight section

48 side angle

50 first contact area

51 second contact area

1. A self-adhesive balancing weight for a vehicle wheel, the weight comprising:
a top surface and a bottom surface,
wherein the bottom surface is an attachment surface with a self-adhesive tape thereon,
the bottom surface has a first curved section with a first radius, a second curved section with a second radius, and a third curved section with a third radius,
the self-adhesive tape is disposed on the first curved section, on the second curved section, and on the third curved section,
the first radius is smaller than the second radius, and
the first, second and third curved sections are convex.

2. The self-adhesive balancing weight according to claim 1, wherein
the self-adhesive tape covers the first curved section and the second curved section as viewed in first and second directions that are tangential to the first and second curved sections, respectively.

3. The self-adhesive balancing weight according to claim 1, wherein
the first curved section and the second curved section are configured to form contact with the rim along at least one contact line via the self-adhesive tape, when the weight is applied to the rim.

4. The self-adhesive balancing weight according to claim 1, wherein
the center axis of the second radius is outside of the balancing weight.

5. The self-adhesive balancing weight according to claim 1, wherein
at least one straight section is provided between a curved section, from the second and third curved sections, and the top surface.

6. The self-adhesive balancing weight according to claim 1, further comprising:
a straight section at at least one of the following locations: (i) between the first curved section and the second curved section, and (ii) between the first curved section and the third curved section.

7. The self-adhesive balancing weight according to claim 1, wherein
the first radius is ½ of the second radius or
the first radius is ⅕ of the second radius.

8. The self-adhesive balancing weight according to claim 1, wherein at least one of the following conditions Is satisfied:
(i) the first radius is 4 mm and the second radius is 8 mm, wherein a tolerance of values of the first and second radii is +/−50%, and
(ii) the first radius is 1.8 mm and the second radius is 9 mm, wherein the tolerance of values of the first and second radii is +/−50%.

9. The self-adhesive balancing weight according to claim 1, wherein the center axis of the first radius passes through the balancing weight.

10. The self-adhesive balancing weight according to claim 1, wherein the second radius is equal to the third radius.

11. The self-adhesive balancing weight according to claim 1, wherein
the balancing weight comprises at least one insert element, the insert element further comprising a ferromagnetic material.

12. The self-adhesive balancing weight according to claim 1, wherein
the balancing weight comprises at least one recess at the bottom surface.

13. A chain of balancing weights comprising a plurality of balancing weights according to claim 1, wherein
balancing weights in said plurality are interconnected by the self-adhesive tape.

14. The chain of balancing weights according to claim 13, wherein
gaps or cutouts are provided at one or both sides of the self-adhesive tape.

15. The chain of balancing weights according to claim 14, wherein said gaps or cutouts are located between balancing weights of the chain.

16. The self-adhesive balancing weight according to claim 2, wherein the self-adhesive tape further covers the curved surface section as viewed in a third direction that is tangential to the third curved surface section.

17. The self-adhesive balancing weight according to claim 8, wherein the tolerance is +/−30%.
